(19) United States
(12) Patent Application Publication
(10) Pub. No.: US 2024/0220374 A1
(43) Pub. Date: Jul. 4, 2024

(54) METHOD OF MAKING EFFICIENT BACKUP SPACE FOR ORIGINAL FILE USING DIFFERENCE (DELTA) EXTRACTION METHOD IN DISARMING OPERATION AND APPARATUS THEREFOR

(71) Applicant: SECULETTER CO., LTD., Seongnam-si, Gyeonggi-do (KR)

(72) Inventor: Seung Won LEE, Seoul (KR)

(73) Assignee: SECULETTER CO., LTD., Seongnam-si, Gyeonggi-do (KR)

(21) Appl. No.: 17/780,146

(22) PCT Filed: May 25, 2022
(86) PCT No.: PCT/KR2022/007444

§ 371 Date: Nov. 30, 2023

(51) Int. Cl. G06F 11/14; G06F 16/16; G06F 16/17

(52) U.S. Cl. CPC G06F 11/1469; G06F 16/162; G06F 16/1727; G06F 2201/84

(57) ABSTRACT

This specification relates to a method of disarming, by a server, a non-portable executable (non-PE) file. The method may include generating an original document file and a disarming document file by performing the disarming on the non-PE file, determining whether the original document file and the disarming document file are identical with each other, generating a delta file for the original document file and the disarming document file based on the original document file and the disarming document file being not identical with each other, storing the disarming document file and the delta file, and deleting the original document file from a main memory.

### TECHNICAL FIELD

This specification relates to a method and apparatus for making efficient a backup space for an original file using a method of extracting a difference before and after a document disarming operation.

### BACKGROUND ART

In an advanced persistent threat (APT) attack, in order for an attacker to determine a specific target and steal targeted information, various types of malware are persistently used by applying a high-level attack scheme. In particular, an APT attack is not detected at an initial intrusion stage in many cases. A non-portable executable (non-PE) file including malware is chiefly used in the APT attack.

A document disarming solution is a security solution for fundamentally blocking a malicious act intended by a hacker by removing only document actions (e.g., HyperLink and VBA macro) which become possible threat elements within a malicious non-PE file (e.g., DOC, HWP, or PDF) that includes such malware.

In general, in such a document disarming solution, an original document is separately backed up. Accordingly, in an abnormal situation, such as that a document file is damaged due to a bug of disarming software, or if a user wants an original document file that is not disarmed, the document disarming solution may provide a backed-up original document.

Furthermore, the document disarming solution needs to dually back up and keep a disarmed document and an original document because the documents need to be backed up and kept for a given period in view of the characteristic of a security solution.

Such a document disarming solution causes a severe disk space shortage phenomenon and requires a disc having a higher capacity. Accordingly, there is a problem in unreason, such as increased costs and degraded backup efficiency.

### DISCLOSURE

### Technical Problem

Various embodiments are directed to proposing a method and apparatus for solving a waste problem in a disk space for the backup of an original document file, which essentially occurs in a document disarming security solution.

Technical objects to be achieved by this specification are not limited to the aforementioned object, and the other objects not described above may be evidently understood from the following detailed description of the specification by a person having ordinary knowledge in the art to which this specification pertains.

### Technical Solution

In an embodiment, a method of disarming, by a server, a non-portable executable (non-PE) file may include generating an original document file and a disarming document file by performing the disarming on the non-PE file, determining whether the original document file and the disarming document file are identical with each other, generating a delta file for the original document file and the disarming document file based on the original document file and the disarming document file being not identical with each other, storing the disarming document file and the delta file, and deleting the original document file from a main memory.

Furthermore, the generating of the delta file may include setting the disarming document file as a first reference file and setting the original document file as a comparison file.

Furthermore, the method may further include storing the original document file in a cache memory.

Furthermore, the method may further include restoring the original document based on the disarming document file and the delta file.

Furthermore, the restoring of the original document may be based on the original document being not searched for in the cache memory.

Furthermore, the method may further include storing the restored original document in the cache memory.

Furthermore, the restoring of the original document may include inputting the disarming document file to a delta generation utility as a second reference file, and inputting the delta file.

In another embodiment, a server for disarming a non-PE file may include a communication unit, a memory including a contents disarm and reconstruction (CDR) engine for performing the disarming and a cache memory, and a processor configured to functionally control the communication unit and the memory. The processor may generate an original document file and a disarming document file by performing the disarming on the non-PE file, may determine whether the original document file and the disarming document file are identical with each other, may generate a delta file for the original document file and the disarming document file based on the original document file and the disarming document file being not identical with each other, may store the disarming document file and the delta file in the memory, and may delete the original document file from the memory.

In still another embodiment, a method of requesting, by a terminal, the restoration of an original document, that is, a disarming target, may include receiving, from a input through a button for requesting the user, an restoration of the original document, transmitting an original document request message to a server as a response to the input through the button for requesting the restoration of the original document, receiving the restored original document from the server as a response to the original document request message, and displaying, for the user, an icon indicating that the restored original document has been received. The restored original document may be restored by using a delta file based on the original document and a disarming document which is a result of the disarming.

### Advantageous Effects

According to an embodiment of this specification, the method of storing a disarming document and delta according to this specification is advantageous in making efficient a storage space and costs, compared to the existing method of simultaneously storing an original document and a disarming document in a document disarming security solution.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a block diagram for describing an electronic device related to this specification.

FIG. 2 is a diagram illustrating a server or a client related to this specification.

FIG. 3 is an example of an abnormal input which may be applied to this specification.

FIG. 4 exemplifies a method of keeping a disarming document to which this specification may be applied.

FIG. 5 is an example of the restoration of an original document to which this specification may be applied.

FIG. 6 is an example a screen of a terminal to which this specification may be applied.

The accompany drawings, which are included as part of the detailed description in order to help understanding of this specification, provide embodiments of this specification and describe the technical characteristics of this specification along with the detailed description.

### MODE FOR INVENTION

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “ . . . unit” used in this specification means a software or hardware element, and the “ . . . unit” performs specific tasks. However, the term “ . . . unit” does not mean that it is limited to software or hardware. The “ . . . unit” may be configured to reside on an addressable storage medium and configured to operate one or more processors. Accordingly, examples of the “ . . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, arrays, and variables. The functionalities provided in the elements and the “ . . . units” may be combined into fewer elements and “ . . . units”, or may be further separated into additional elements and “ . . . units”.

Furthermore, “ . . . unit” according to an embodiment of this specification may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC), a programmable logic device (PLD), a field programmable gate array (FPGA), etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may be in the electronic communication state with the processor.

The concept of a “non-PE file” used in this specification is opposite to the concept of a PE file or an executable file, and the “non-PE file” means a file that is not autonomously executed. For example, the non-PE file may be a document file such as a PDF file, a Hangul file, or a MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

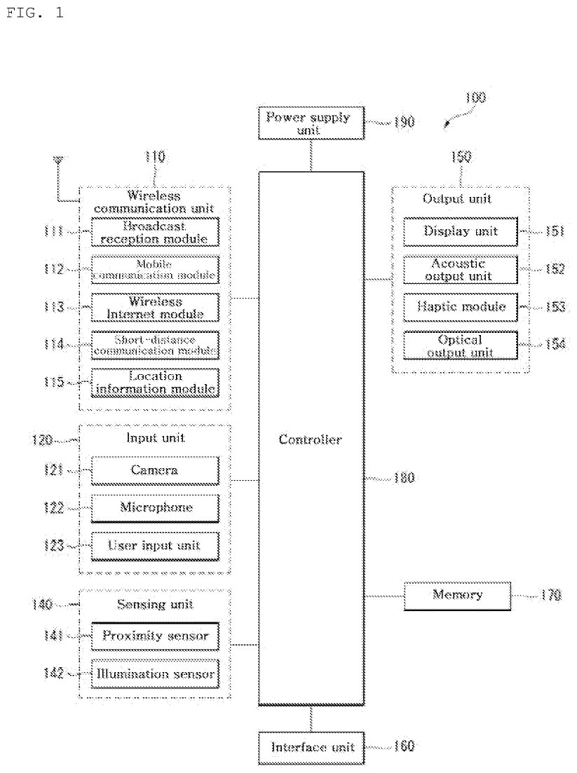

FIG. 1 is a block diagram for describing an electronic device related to this specification.

An electronic device 100 may include a wireless communication unit 110, an input unit 120, a sensing unit 140, an output unit 150, an interface unit 160, a memory 170, a controller 180, a power supply unit 190, etc. The elements illustrated in FIG. 1 are not essential for implementing the electronic device. The electronic device described in this specification may include more or less elements than the listed elements.

More specifically, among the elements, the wireless communication unit 110 may include one or more modules which enable wireless communication between the electronic device 100 and a wireless communication system, between the electronic device 100 and another electronic device 100, or between the electronic device 100 and an external server.

Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-distance communication module 114, and a location information module 115.

The input unit 120 may include a camera 121 or an image input unit for receiving an image signal, a microphone 122 or an audio input unit for receiving an audio signal, and a user input unit 123 (e.g., a touch key or a mechanical key) for receiving information from a user. Voice data or image data collected by the input unit 120 may be analyzed and processed as a control command of a user.

The sensing unit 140 may include one or more sensors for sensing at least one of information within the electronic device, information about a surrounding environment that surrounds the electronic device, and user information. For example, the sensing unit 140 may include at least one of a proximity sensor 141, an illumination sensor 142, a touch sensor, an acceleration sensor, a magnetic sensor, a gravity (G)-sensor, a gyroscope sensor, a motion sensor, an RGB sensor, an infrared (IR) sensor, a finger scan sensor, an ultrasonic sensor, an optical sensor (e.g., the camera 121), the microphone 122, a battery gauge, an environment sensor (e.g., a barometer, a soil hygrometer, a thermometer, a radioactivity detection sensor, a heat detection sensor, or a gas detection sensor), a chemical sensor (e.g., an electronic nose, a healthcare sensor, or a bio recognition sensor). The electronic device disclosed in this specification may combine and use pieces of information sensed by at least two of the sensor.

The output unit 150 is for generating an output that is related to a visual sense, an auditory sense, or a tactile sense, and may include at least one of a display unit 151, an acoustic output unit 152, a haptic module 153, and an optical output unit 154. The display unit 151 may implement a touch screen by forming a mutual layer structure with a touch sensor or by being formed along with the touch sensor in an integrated way. The touch screen may function as the user input unit 123 that provides an input interface between the electronic device 100 and a user, and may also provide an output interface between the electronic device 100 and a user.

The interface unit 160 plays a role as a passage with various types of external devices that are connected to the electronic device 100. The interface unit 160 may include at least one of a wired/wireless headset port, an external charger port, a wired/wireless data port, a memory card port, a port that connects a device having an identification module, an audio input/output (I/O) port, a video I/O port, and an earphone port. The electronic device 100 may perform proper control that is related to an external device connected thereto, based on the external device being connected to the interface unit 160.

Furthermore, the memory 170 stores data that supports various functions of the electronic device 100. The memory 170 may store multiple application programs (or applications) that are driven in the electronic device 100, data for an operation of the electronic device 100, and instructions. At least some of such application programs may be downloaded from an external server through wireless communication. Furthermore, at least some of the application s may be present in the electronic device 100 from the time of release for basic functions (e.g., incoming, outgoing, receiving messages, and outgoing functions) of the electronic device 100. The application program may be stored in the memory 170, may be installed in the electronic device 100, and may be driven to perform an operation (or function) of the electronic device by the controller 180.

The controller 180 commonly controls an overall operation of the electronic device 100 in addition to an operation related to the application program. The controller 180 may provide or process information or a function suitable for a user by processing a signal, data, or information that is input or output through the aforementioned elements or driving the application program stored in the memory 170.

Furthermore, the controller 180 may control at least some of the elements described with reference to FIG. 1 in order to drive the application program stored in the memory 170. Moreover, the controller 180 may combine and operate at least two of the elements included in the electronic device 100 for the driving of the application program.

The power supply unit 190 is supplied with external power and internal power and supplies power to each of the elements included in the electronic device 100, under the control of the controller 180. The power supply unit 190 includes a battery. The battery may be an embedded battery or a battery having a replaceable form.

At least some of the elements may cooperate with each other and operate in order to implement an operation, control, or a control method of the electronic device according to various embodiments that are described below. Furthermore, an operation, control, or a control method of the electronic device may be implemented in the electronic device by the driving of at least one application program stored in the memory 170.

In this specification, a server (or a cloud server) or a client may include the electronic device 100. The electronic device 100 may be collectively called a terminal.

The terminal may be connected to an external server (or a cloud server) or a client over a network, and may communicate therewith.

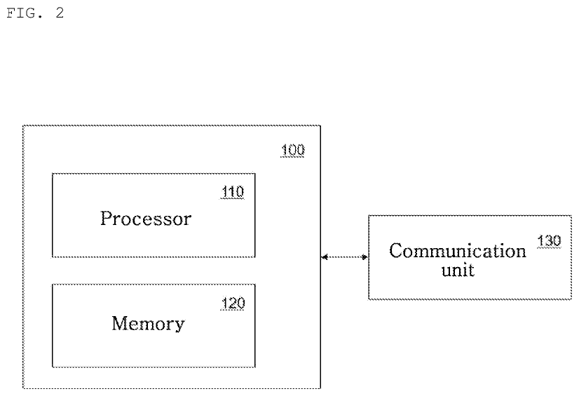

FIG. 2 is a diagram illustrating a server or a client related to this specification.

In this specification, the server (or a cloud server) or the client may include a controller 200 and a communication unit 230. The controller 200 may include a processor 210 and a memory 220. The processor 210 may perform instructions stored in the memory 220. The processor 210 may control the communication unit 230. The memory 220 may include a cache memory. The cache memory may temporarily store an original document to be described later for a given time.

The processor 210 may control an operation of the server or the client based on an instruction that is stored in the memory 220. The server or the client may include one processor, or may include a plurality of processors. If the server or the client includes a plurality of processors, at least some of the plurality of processors may be disposed at places that are physically spaced apart from each other. Furthermore, the server or the client is not limited thereto, and may be implemented by using various known methods.

The communication unit 230 may include one or more modules that enable wireless communication between the server or the client and a wireless communication system, between the server or the client and another server or client, or between the server or the client and an external server (or terminal). Furthermore, the communication unit 210 may include one or more modules that connect the server or the client to one or more networks.

The controller 200 may control at least some of the elements of the server or the client in order to drive an application program that is stored in the memory 220. Moreover, the controller 200 may combine and drive at least two of the elements that are included in the server or the client in order to drive the application program.

In this specification, the server may include a reversing engine or/and a contents disarm and reconstruction (CDR) engine that provides CDR services.

### Reversing Engine

A reversing engine is an analysis/diagnosis engine obtained by automating a reverse engineering (reversing) process for a malicious non-PE file.

For example, the reversing engine may perform the following steps.

1. File analysis: this is a step of analyzing an appearance (e.g., properties, an author, a date created, or a file type) of a non-PE file itself. In this step, whether a non-PE file is malicious may be diagnosed based on only information of the non-PE file itself like a common vaccine program.

2. Static analysis: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for a macro, the extraction and analysis of a URL, etc.

3. Dynamic analysis: this is a step of determining whether a non-PE file is malicious by analyzing an act of the non-PE file while executing and monitoring the non-PE file. If this step is used, a malicious act using a normal function, such as a macro, a hyperlink, or DDE, can be easily detected.

4. Debugging analysis: this is a step of analyzing vulnerability, exploits, etc. by executing and debugging a non-PE file. This step is suitable for detecting the vulnerability of an application program using a body, a table, a font, a picture, etc. within a document, including a macro, a hyperlink, or DDE.

The reversing engine may include a debugging engine which may be used in debugging analysis. The debugging engine can diagnose vulnerability which occurs in a document input, processing, and output stage by debugging a process of reading a non-PE file. In this case, the vulnerability relates to an error, a bug or the like, which occurs when an application program receives an unexpected value in a code (or logic) developed by a developer of the application program. An attacker may execute a malicious act, such as the denial of service attributable to abnormal termination or the remote execution of a code, through the vulnerability.

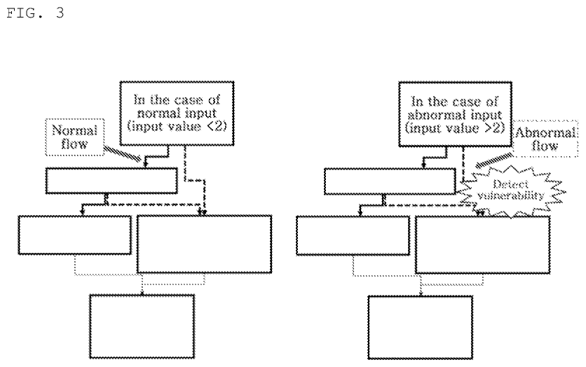

FIG. 3 is an example of an abnormal input which may be applied to this specification.

Referring to FIG. 3, when receiving an abnormal value (e.g., when an input value is greater than 2, that is, a normal range) through a non-PE file, an execution flow of an application program changes into an execution flow not intended by a developer, so that vulnerability may occur. The debugging engine may set a break point at a specific point that is related to the vulnerability by automatically debugging a document reading process, may check the specific value related to the input value, and may diagnose whether the non-PE file is malicious by determining whether the input value is a value that causes the vulnerability.

More specifically, the debugging engine may start debugging by checking the non-PE file and executing the application program for reading the non-PE file. When a module is loaded in the process of reading the non-PE file, the debugging engine may check whether the corresponding module is an analysis target module, and may set the break point at a designated address when the corresponding module is an analysis target.

For example, a non-PE file may have branch points at which an application program is terminated or a flow of the application program branches into a flow in which any malicious act does not occur when a version of the application program or a specific condition, such as an operating system environment, is not satisfied. The server may set a break point at a branch point that is previously analyzed by an analyst and that has such a possibility.

Furthermore, the server may set conditions on which the server may continue to execute the application program without terminating the application program or may induce a flow of the application program into a flow in which a malicious act may occur, in association with a corresponding branch point.

If a process of the application program is stopped at a corresponding break point during the process, the server may perform a step of detecting the occurrence of vulnerability through detection logic and then storing the results of the detection in an analysis report.

The automation reversing engine that is included in the server can diagnose and block a malicious non-PE file through a diagnosis algorithm researched and developed by an analyst, by analyzing the aforementioned steps while automatically performing the aforementioned steps.

### Contents Disarm and Reconstruction (CDR)

A CDR service is a solution that generates a new file by decomposing a non-PE file, removing a malicious file or an unnecessary file from the non-PE file, and making content therein identical with the original as much as possible.

That is, CDR means a service that generates a safe document by disarming and reconstructing content within a document and that provides the safe document to a customer. A disarming target file may include all non-PE files (e.g., a MS Word, Excel, PowerPoint, a Hangul, and a PDF). Disarming target content may be active content (e.g., a macro, a hyperlink, and an OLE object).

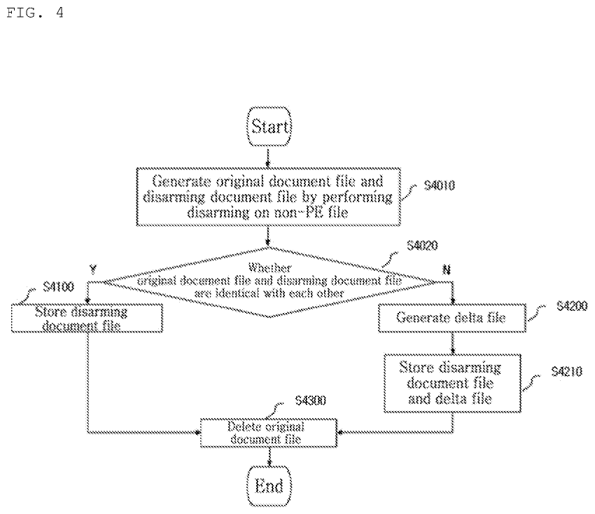

FIG. 4 exemplifies a method of keeping a disarming document to which this specification may be applied.

Referring to FIG. 4, the server generates an original document file and a disarming document file by performing disarming on a non-PE file (S4010).

The server determines whether the original document file and the disarming document file are identical with each other (S4020). For example, if the original document does not include a disarming target, the server may determine that the original document file and the disarming document file are identical with each other.

If it is determined that the original document file and the disarming document file are identical with each other, the server stores the disarming document file (S4100).

If it is determined that the original document file and the disarming document file are not identical with each other, the server generates a delta file based on the original document file and the disarming document file (S4200).

More specifically, the server may generate delta by using a “binary diff algorithm.” All digital files that are used in a computer have a binary form (binary=0 or 1). The binary diff algorithm may compare such files having the binary form in order to obtain a difference between the files.

The server may generate the delta by using a known open source algorithm.

For example, the server may generate the delta, that is, a difference between “1. malicious original.doc” document and “2. disarming.doc” document by using a delta generation utility (e.g., xdelta3.exe).

The server may generate the delta by using the disarming document file as a reference file and using the original document file as a comparison file.

Table 1 exemplifies a relation between the original document file, the disarming document file, and the delta file.

TABLE 1

disarming document file (reference file) − original
document file (comparison file) = delta file
Example: 2. disarming.doc” − “1. malicious original.doc” =
delta

Referring to Table 1, the size of the delta file may be smaller than a difference between the sizes of the original document file and the disarming document file according to a compression rate of the delta generation utility. For example, a difference between actual sizes of “1. malicious original.doc” (58,368 bytes) document file and “2. disarming.doc” (46,592 bytes) document file is 11,776 bytes. However, the size of the delta file generated by the xdelta3 utility, that is, a difference between the original document file and the disarming document file, may be merely 5,013 bytes.

That is, since the delta file itself is compressed and generated, the server may derive higher storage space efficiency.

The server stores the disarming document file and the delta file (S4210).

The server deletes the original document file from a main memory (S4300). For example, the server may delete the original document file from the main memory, and may store the original document file in the cache memory for a given time.

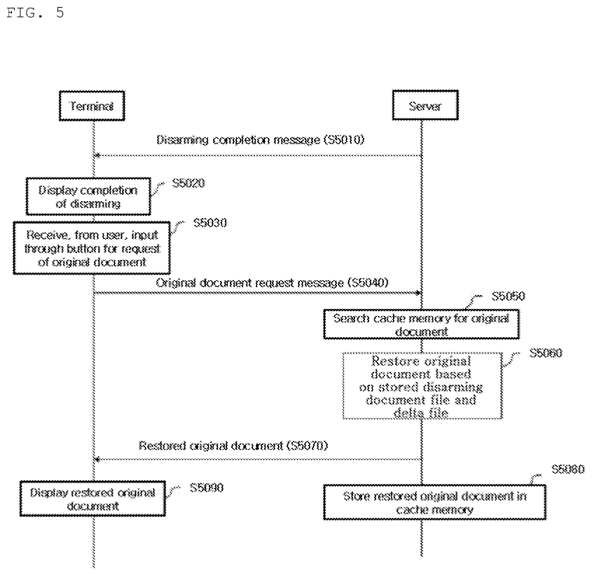

FIG. 5 is an example of the restoration of an original document to which this specification may be applied.

Referring to FIG. 5, the server may be in the state in which the server has deleted an original document file and has stored a disarming document file and a delta file. When a user requests the original document file through a terminal, the server may restore an original document by using the disarming document file and the delta file that are kept in the server. To this end, the terminal may include an application program for controlling an operation of the server.

The terminal receives, from the server, a message that provides notification that the disarming of the original document has been completed (S5010).

The terminal displays that the disarming has been completed for the user (S5020).

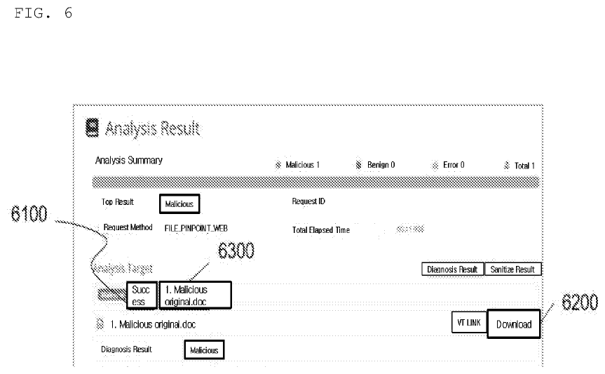

FIG. 6 is an example a screen of the terminal to which this specification may be applied.

Referring to FIG. 6, a user may control a disarming task of the server through an application program installed in a terminal. The terminal may display, on a screen 6100, a button indicative of a success for the user in order to indicate that the disarming task has been completed. Furthermore, the terminal may display a button 6200 for requesting an original document from the user.

The terminal receives, from the user, an input through the button for the request of the original document (S5030).

The terminal transmits an original document request message to the server as a response to the button input for the request of the original document (S5040). For example, the original document request message includes information of the original document to be requested by the user.

The server searches a cache memory for the original document based on the information of the original document (S5050). For example, the cache memory may store the most recent original document file for a given period. Furthermore, the cache memory may automatically delete a file stored therein when a given time elapses.

When the original document is retrieved, the server may transmit, to the terminal, the original document stored in the cache memory as a restored original document.

The server restores the original document based on a disarming document file and a delta file stored therein (S5060). For example, when the original document is not searched for in the cache memory, the server may perform a task for restoring the original document. The server may restore the original document by using a disarming document file stored therein as a reference file.

Table 2 exemplifies a relation between the disarming document file, the delta file, and the restored original document file.

TABLE 2

disarming document file (reference file) + delta file =
restored original document file (result file) Example: 2.
disarming.doc” + delta = “1. malicious original.doc

Referring to Table 2, the task for restoring the original document may be performed by the server in the reverse order of the task in FIG. 4. For example, the server may input <reference file> and <delta file> to the delta generation utility, and may generate <result file> as the results of the execution of a program. The server may not store the document file “1. malicious original.doc” by using the document file “2. disarming.doc” as a reference file.

The server may transmit the restored original document to the terminal as a response to the original document request message (S5070). When the original document is retrieved from the cache memory by the server in step S5050, the server may directly transmit the original document of the cache memory to the terminal without performing the task for restoring the original document.

The server stores the restored original document in the cache memory (S5080). If the original document has already been stored in the cache memory, the server does not redundantly store the restored original document.

The terminal displays the restored original document for the user (S5090).

Referring back to FIG. 6, the terminal that has received the original document may store the received original document and may display, for the user, an icon and text 6300 for notifying the user of the original document. Accordingly, the user can read the restored original document or the original document that has been stored in the existing cache memory.

1) A task product of the CDR solution is a “disarming document”, which has a smaller file size than an “original document.” 2) The two files are externally very similar to each other, other than an element removed therefrom. Accordingly, the suitability of the file difference (delta) determination technology based on the binary diff algorithm for such a CDR solution is excellent.

In this specification, the server can greatly improve disk space efficiency by grafting the delta technology to the CDR solution. Furthermore, a storage space and costs can be made efficient because the “disarming document” & “delta” storage method occupies only a disk space of about ½ level compared to the existing “original document” & “disarming document” simultaneous-storage method.

The aforementioned present disclosure may be implemented in a medium on which a program has been recorded as a computer-readable code. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

1. A method of disarming, by a server, a non-portable executable (non-PE) file, the method comprising:
generating an original document file and a disarming document file by performing the disarming on the non-PE file;
determining whether the original document file and the disarming document file are identical with each other;
generating a delta file for the original document file and the disarming document file based on the original document file and the disarming document file being not identical with each other;
storing the disarming document file and the delta file; and
deleting the original document file from a main memory.

2. The method of claim 1, wherein the generating of the delta file comprises:
setting the disarming document file as a first reference file; and
setting the original document file as a comparison file.

3. The method of claim 2, further comprising storing the original document file in a cache memory.

4. The method of claim 3, further comprising restoring the original document based on the disarming document file and the delta file.

5. The method of claim 4, wherein the restoring of the original document is based on the original document being not searched for in the cache memory.

6. The method of claim 5, further comprising storing the restored original document in the cache memory.

7. The method of claim 5, wherein the restoring of the original document comprises:
inputting the disarming document file to a delta generation utility as a second reference file, and
inputting the delta file.

8. A server for disarming a non-PE file, comprising:
a communication unit;
a memory comprising a contents disarm and reconstruction (CDR) engine for performing the disarming and a cache memory; and
a processor configured to functionally control the communication unit and the memory,
wherein the processor is configured to generate an original document file and a disarming document file by performing the disarming on the non-PE file, determine whether the original document file and the disarming document file are identical with each other, generate a delta file for the original document file and the disarming document file based on the original document file and the disarming document file being not identical with each other, store the disarming document file and the delta file in the memory, and delete the original document file from the memory.

9. A method of requesting, by a terminal, a restoration of an original document which is a disarming target, the method comprising:
receiving, from a user, an input through a button for requesting a restoration of the original document;
transmitting an original document request message to a server as a response to the input through the button for requesting the restoration of the original document;
receiving a restored original document from the server as a response to the original document request message; and
displaying, for the user, an icon indicating that the restored original document has been received,
wherein the restored original document is restored by using a delta file based on the original document and a disarming document which is a result of the disarming.
